(19) United States
(12) Patent Application Publication
(10) Pub. No.: US 2023/0095982 A1
(43) Pub. Date: Mar. 30, 2023

(54) SYSTEM AND METHOD FOR DIRECT ELECTROLESS PLATING OF 3D-PRINTABLE GLASS FOR SELECTIVE SURFACE PATTERNING

(71) Applicant: Lawrence Livermore National Security, LLC, Livermore, CA (US)

(72) Inventors: Nikola DUDUKOVIC, Hayward, CA (US); Rebecca DYLLA-SPEARS, Dublin, CA (US); Megan Elizabeth ELLIS, Jamesport, MO (US)

(21) Appl. No.: 17/488,453

(22) Filed: Sep. 29, 2021

(51) Int. Cl. C23C 18/18; C23C 18/44; C03C 17/10; C03B 19/06; B33Y 10/00

(52) U.S. Cl. CPC C23C 18/1865; C23C 18/44; C03C 17/10; C03B 19/06; B33Y 10/00; C03C 2218/13; C03C 2218/31

(57) ABSTRACT

The present disclosure relates to a method for forming a glass structure having a metallized surface portion. The method may comprise forming a structure using a flowable first material, adapted to form a glass, which includes a metal component. The structure is then treated to remove substantially all solvents and organic components contained in the first flowable material. Finally, the structure is exposed to a bath of a metal salt during which nucleation occurs and a metallized surface coating is formed on at least a portion of an outer surface of the structure.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to systems and methods for making glass structures, and more particularly to systems and methods having for producing a consolidated glass structure with a metallized outer surface coating formed thereon, which has excellent adhesion.

### BACKGROUND

The statements in this section merely provide background information related to the present disclosure and may not constitute prior art.

Glass is a material with many desirable properties (transparency, chemical inertness, low thermal expansion, etc.). In previous work at Lawrence Livermore National Laboratory, 3D printing of transparent glass of single and multi-material compositions to produce complex shapes and optics (Nguyen et al., Advanced Materials 2017, Dudukovic et al. ACS Applied Nano Materials 2018, Dylla-Spears et al. Science Advances 2020) has been demonstrated. Coating glasses with metals, however, can be challenging and time-consuming.

Chemical or physical vapor deposition processes (e.g., sputtering, e-beam deposition) tend to be line-of-sight methods and expensive. Solution-based electroless deposition can be used as a cheaper and shape-conformal alternative. However, electroless deposition suffers from poor adhesion, and typically requires many time-consuming pretreatment steps.

Previous work in this area has shown that a series of glass surface functionalization steps, including the addition of titania (TiO₂) to improve adhesion and palladium (Pd) to activate the surface, enabled uniform electroless deposition of copper with good adhesion. For example, see Miller, Alexander, et al., “Electrochemical copper metallization of glass substrates mediated by solution-phase deposition of adhesion-promoting layers”, Journal of The Electrochemical Society 162.14 (2015): D630.

In spite of recent developments involving the coating of glass, there remains a need for systems and methods which enable coatings to be applied to glass without the above described limitations and drawbacks.

### SUMMARY

This section provides a general summary of the disclosure, and is not a comprehensive disclosure of its full scope or all of its features.

In one aspect the present disclosure relates to a method for forming a glass structure having a metallized surface portion. The method may comprise forming a structure using a flowable first material, adapted to form a glass, which includes a metal component. The method may further include treating the structure to remove substantially all solvents and organic components contained in the first flowable material. The method may further include exposing the structure to a bath containing a metal salt during which nucleation occurs and a metallic surface coating is formed on at least a portion of an outer surface of the structure.

In another aspect the present disclosure relates to a method for forming a glass structure having a metallized surface portion. The method may comprise carrying out an additive manufacturing operation to form a structure using a flowable first material and a second flowable material, wherein the first flowable material includes SiO₂ and the second flowable material differs from the first material and includes a metal salt mixture. The second flowable material is applied to form at least a designated portion of an outer surface of the structure. The method further may include treating the structure to remove substantially all solvents and organic components contained in the first flowable material, and then exposing the structure to a bath of a metal salt solution. Exposure to the metal salt solution causes nucleation to occur, which forms a metallized surface coating on at least the designated portion of the outer surface of the structure.

In still another aspect the present disclosure relates to a method for forming a glass structure having a metallized surface portion. The method may comprise carrying out an additive manufacturing operation to form a structure using a first flowable material and a second flowable material, wherein the first flowable material includes SiO₂ and the second flowable material differs from the first flowable material and includes a metal salt mixture, and wherein the second flowable material is applied to form at least a designated portion of an outer surface of the structure and the first flowable material forms a remainder of the structure. The method may further include heating the structure during a drying/burnout operation to remove substantially all solvents and organic components contained in the first flowable material. The method may further include sintering the structure to produce a consolidated structure, and then exposing the consolidated structure to a bath of a metal salt solution. During the exposure to the metal salt solution, nucleation occurs and a metallized surface coating is formed on the designated portion of the outer surface of the structure.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a high diagram of operations that may be performed to create a glass structure with a metallized coating, in accordance with one embodiment of the present disclosure.

FIG. 2 is a high level side view diagram illustrating how an entire outer surface of a structure doped with one or more metallic components (e.g., TiO₂ and Pd in this example) can be coated using the method of the present disclosure;

FIG. 3 is a high level side cross sectional diagram of a structure in which the flowable doped material (e.g., ink) has been applied selectively when 3D printing the structure to form spaced apart, doped channels, which enables a corresponding patterned metallic surface (e.g., copper in this example) to be formed on the outer surface of the structure;

FIG. 4 is a high level plan view of another structure formed using a flowable undoped material (e.g., SiO₂), and wherein a serpentine pattern has been 3D printed in the structure using a flowable doped ink (e.g., SiO₂ with one or both of TiO₂ and Pd), which enables a corresponding metallized serpentine pattern to be formed on the outer surface of the structure after the structure is exposed to the salt bath operation shown in FIG. 1;

FIG. 5 is a plan view image of a structure formed in a laboratory environment wherein a left side portion of a glass structure was formed using an undoped ink, and the right side portion was formed using a doped ink; and

FIG. 6 is a plan view of the structure of FIG. 5 after the structure has been exposed to a bath containing a metal salt solution, to further illustrate how a predetermined metal or metal alloy pattern can be applied to just the outer surface portion of a glass structure which has been constructed of the doped ink.

### DETAILED DESCRIPTION

Example embodiments will now be described more fully with reference to the accompanying drawings.

The present disclosure overcomes the limitation of previous systems and methods with a new approach that incorporates dopants (including but not limited to TiO₂ and Pd) into slurries and inks for 3D printing of glass components, which can then be directly plated. By using slurries and inks, this provides the ability to spatially control the composition of the glass, and one can then 3D print glass with prescribed patterns of doped composition (e.g., a silica glass where certain regions are doped with TiO₂ and Pd). When the entire glass construct is placed in the electroless plating bath, only the doped regions are metallized.

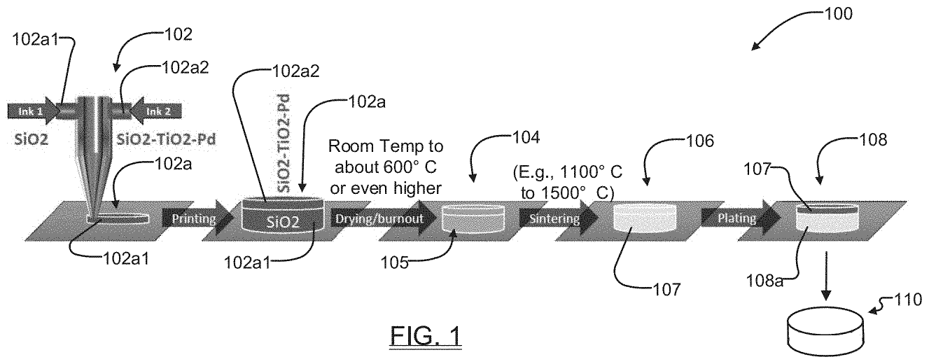

Referring now to FIG. 1, a high level process 100 is shown for producing a plated glass structure having a metallized outer surface coating, in accordance with the present disclosure. The present disclosure involves the use of additive manufacturing (AM) or 3D printing methods, as indicated at operation 100a, which enables the fabrication of complex, near-arbitrary shapes. The AM printing methods described here can include, but are not limited to, the following technologies:

1) Direct ink writing (DIW), which is illustrated at operation 102 in FIG. 1, which is an extrusion-based method in which a green body is printed from one or multiple inks (e.g., particle suspensions or sol-gel materials). The green body is then thermally treated to remove all solvents, burned out of all traces of organic compounds, and sintered to full density glass. DIW can be single material printing or multi-material printing, with multiple inks being spatially patterned in desired discrete or gradient compositions.

2) Light-based methods such as stereolithography, in which a light pattern is projected to polymerize a photosensitive resin that can later be processed to glass. The process is repeated layer by layer until a 3D object is produced. The light source can be, for example, a digital light projector or a laser. The printed green body may then be subsequently treated to produce glass.

3) Direct melting methods, in which a glass powder, rod, fiber or other source material is melted using a laser or a high-temperature nozzle to pattern a desired shape.

4) Binder jetting methods, in which a bed of glass powder is patterned with a binder, layer by layer, to produce a 3D object. The printed construct is then thermally treated to remove the binder or other organics and sintered to full density.

All of the 3D AM printing methods described above can be adapted to produce multi-material constructs from the feedstock materials. By 3D printing a shape in which multiple different materials are patterned, one can produce a glass part or structure with a spatially varying composition throughout its thickness and/or volume. In this way, the printed glass part or structure can be printed to contain areas that are plating-ready, and areas that are plating-inert (for example, silica glass doped with TiO₂/Pd and undoped silica glass, respectively).

Print operation 102 in FIG. 1 illustrates a print nozzle 102a being used to deposit a flowable first ink 102a1, comprised of SiO₂, to form a first, glass, portion 102a1 (i.e., an undoped portion) of a structure 102a, and then using the print nozzle to apply a flowable second ink 102a2, formed by a salt having a mixture of SiO₂—TiO₂—Pd, to print a surface layer portion (i.e., a doped portion) 102a2 on the glass portion 102a1.

It will be appreciated that an important factor that will enable the plating of a metal is the inclusion of Pd in the flowable first ink 102a1, which acts as the catalyst that will trigger a metal deposition reaction. The TiO₂ will act more as an adhesion promoter. Besides Pd, other metals can serve as “auto-catalysts”. In other words, if one were to incorporate copper ions or particles in the printed glass, one may possibly be able to achieve subsequent deposition of a copper metal film. Similarly, printing a nickel-containing glass may enable one to achieve deposition of a nickel metal film onto the glass. Accordingly, it will be appreciated that the present disclosure is not limited to any particular metals as an additive for the flowable first ink 102a1.

Referring further to FIG. 1, after completion of the printing operation, a drying/burnout operation may then be carried out on the structure 102a, as indicated at operation 104. This drying/burnout operation 106 may actually be two separate operations. For example, the drying action may be carried out to dry out solvents from the structure 102a by exposing the structure 102a to lower temperatures than the burnout operation, for example, temperatures from room temperature up to about 150° C. The drying action may also involve processes like freeze-drying or supercritical drying. The “burnout” portion of the operation refers to mostly the removal of any polymeric binders present in the structure 102a. As such, depending on the polymer, burnout will occur at temperatures typically above about 150° C., to a temperature of up to about 600° C., or even higher, and possibly even all the way up to the sintering temperature of the glass. The overall time period to carry out the drying/burnout operations typically may be between about 24 hours to about 96 hours, depending upon the solvents being used. The drying/burnout operations indicated at operation 104 serve to remove all solvents and organics from the structure 102a, which forms a modified glass structure 105.

Referring further to FIG. 1, after the drying/burnout operation 104 is complete, a sintering operation 106 may be performed to sinter the structure 105, to produce a consolidated glass structure 107. The sintering operation 108 may be performed at a suitable sintering temperature, in one example between about 1100° C. to about 1500° C., for a time period of, for example, about several minutes up to several hours, depending upon the exact sintering temperature used and the exact composition of the structure 105.

Referring further to FIG. 1, after the sintering operation 106 is complete, the consolidated glass structure 107 may be placed in an electroless (i.e., no electric field being used for the plating) bath 108a, as indicated at operation 108, and plated. The bath 108a may contain a suitable solution of a metal salt (e.g., copper sulfate, nickel chloride, etc.) with a reducing agent (e.g., formaldehyde, glyoxylic acid, etc.). The bath 108a can also contain additives such as complexing agents, stabilizers, etc. The bath 108a can optionally be heated to a temperature that allows an optimum rate of deposition. For example, such a temperature may range within about 30° C.−90° C., and will depend on the specific additives, agents and/or stabilizers being used. When the consolidated glass structure 107 is placed in the bath 104a, the additives listed above present in the doped ink 102a2 (e.g., palladium) act as a catalyst for the reduction of the metal species in the solution of the bath 108a. These points on the surface of the consolidated glass structure 107 act as nucleation sites, from which thin film growth proceeds. After the initial catalytic step, the reaction becomes autocatalytic and proceeds until stopped, or until the metal concentration in the solution falls below a critical limit. Typically, the consolidated glass structure 107 may be placed in the solution of the bath 108a for several minutes to several hours, and more typically around 30-60 minutes. After the plating operation 108 is finished, a metal plated, glass structure 110 is produced.

It will be appreciated then that to enable direct plating of glass products with good adhesion, the feedstock should contain additives or catalysts that allow the nucleation of metal deposits. These additives or catalysts can include, but are not limited to: palladium, copper, nickel, gold, silver, carbon, etc., which can be added as particles, salts, or as part of metal-organic polymers. Coatings on silica-based glass generally suffer from poor adhesion, so adhesion promoters (for example, titanium oxide, aluminum oxide, etc.) can be included in the 3D printable glass formulation (i.e., in the ink 102a2) to better enable the deposited metal film to remain on the glass surface and improve damage resistance.

Devices with complex 3D shapes in which the properties of glass, such as transparency, chemical inertness, low thermal expansion, and the properties of metals (e.g., electrical conductivity, thermal conductivity, catalytic activity) are highly beneficial. Examples applications of the present system and method are expected to include, but are not limited to: glass microfluidic devices with conductive traces for electrical sensing or electrowetting; glass electrochemical reactors with catalytically active metal electrodes; lightweight glass optics with reflective metallic coatings, etc.

Referring to FIGS. 2-4, examples of how engineered metallized surface coatings or patterns will be provided. FIG. 2 shows a glass structure 200 upon which a copper surface coating 202 is plated. This may be accomplished through the operations described in connection with FIG. 1. In this example the entire outer surface of the glass structure 200 is covered with the copper surface coating 202.

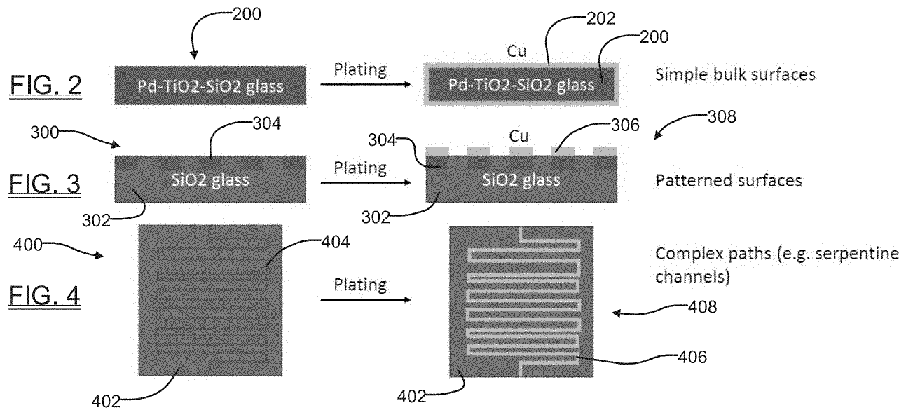

FIG. 3 shows an engineered substrate 300 which has two distinct portions: an undoped SiO₂ portion 302 and a plurality of doped channels 304 formed from a doped material, such as ink 102a2 shown in FIG. 1. In this example a copper surface coating is applied to the substrate 302, and the nucleation occurs only over those areas having the doped material channels 304 to form a new structure 308 having metallized (e.g., copper in this example) surface coatings 306. No copper adheres to the other undoped areas of the substrate 300. The structure 308 thus has an engineered or “patterned”, metallized surface.

FIG. 4 shows another example of a structure 400 where SiO₂ is used to form an undoped portion 402 using primarily SiO₂, while 3D printing is performed using a doped ink (e.g., ink 102a2 in FIG. 1) in a serpentine pattern to form a continuous doped section 404. A metal surface coating 406 can then be formed only on the doped section 404, to thus form a structure 408 having a metallized, serpentine surface pattern,

While the foregoing discussion has focused on using two types of inks, it will be appreciated that a plated structure could be formed simply by using one ink, for example ink 102a2, which is doped to include both SiO₂ and additional components such as Pd. In this instance the entire outer surface of the printed structure could be plated using the herein described electroless plating methods.

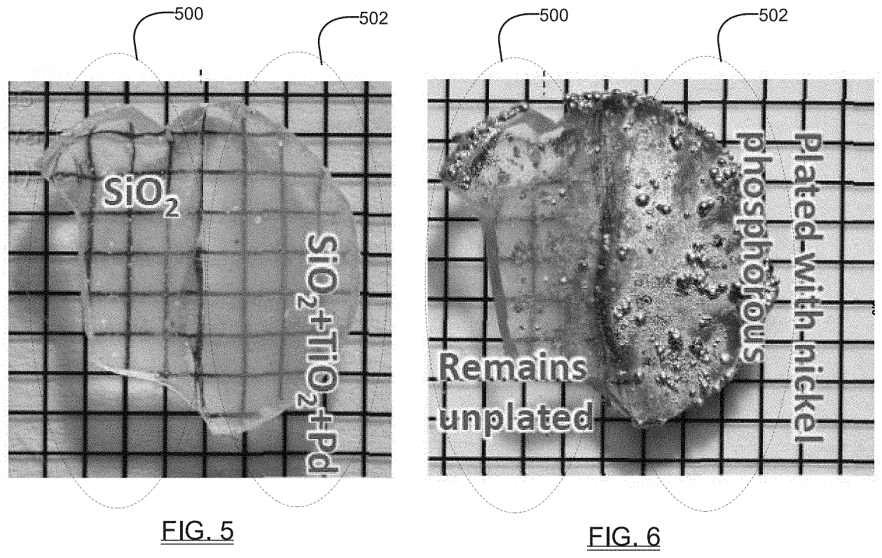

Referring briefly to FIGS. 5 and 6, images of a structure created in a laboratory environment using the methods of the present disclosure are shown. FIG. 5 shows a first portion 500 of a structure created using just SiO₂, while portion 502 was created using a flowable salt mixture of SiO₂+TiO₂+Pd. After exposure to the plating bath containing the salt solution (operation 108 in FIG. 1), nucleation has occurred only for portion 502 of the structure.

The present disclosure thus describes various methods for the design and fabrication of glass surfaces with patterned metallic traces or surface portions. Either a portion or all of the surface may be plated with the chosen metallic material or metallic mixture. The present disclosure overcomes the limitations with previous coating methods, in which silicate glasses are typically difficult to plate, and require many pretreatment steps to ensure uniform deposition and adequate adhesion. Introducing dopants into 3D-printable silica glass preform formulations which include one or more metallic particles or components, enables the fabrication of glass components that can be directly plated via electroless deposition of metals and metal alloys. By using multi-material 3D printing, components with spatially varying glass composition can be produced, such that only selective portions of the glass components are plated during the electroless deposition process. The incorporation of metallic surfaces and patterns allows a wide range of important functionalities such as electrical conductivity, thermal conductivity, and catalytic activity, just to name a few, which can enable the design and fabrication of functional glass devices such as microfluidic circuits, electrochemical reactors, spectroscopy windows, mirrors, and other devices and structures.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

1. A method for forming a glass structure having a metallized surface portion, the method comprising:
forming a glass structure using a flowable material, adapted to form a glass, which includes a catalyst component, such that the catalyst component forms an activated surface of the glass structure and a structural portion of the glass structure;
treating the glass structure to remove substantially all solvents and organic components contained in the flowable material; and
exposing the glass structure to a bath containing a metal salt during which nucleation occurs and a metallic surface coating is formed on at least a portion of an outer surface of the glass structure containing the catalyst component.

2. The method of claim 1, further comprising sintering the glass structure prior to exposing the structure to the bath of metal salt.

3. The method of claim 1, wherein forming a glass structure using a flowable material comprises forming a metal structure using a flowable mixture of a metal component and salt.

4. The method of claim 1, wherein forming the glass structure using a flowable material comprises forming a metal structure using a flowable mixture of salt, SiO₂ and Pd.

5. The method of claim 1, wherein forming the glass structure using a flowable material comprises forming a metal structure using a flowable mixture of salt, SiO₂, TiO₂ and Pd.

6. The method of claim 1, further comprising heating the bath of the metal salt.

7. The method of claim 6, wherein the bath of the metal salt is heated to a temperature of at least about 30° C.

8. The method of claim 1, wherein treating the glass structure comprises performing a drying operation in which the glass structure is heated using a temperature between room temperature up to about 150° C.

9. The method of claim 8, wherein treating the glass structure further comprises performing a burnout operation, after the drying operation is completed, in which the glass structure is further heated to a temperature between about 150° C. to about 600° C.

10. The method of claim 1, wherein the bath of the metal salt comprises at least one of copper sulfate or nickel chloride.

11. The method of claim 10, wherein the bath of metal salt comprises a reducing agent including at least one of formaldehyde and glyoxylic acid.

12. The method of claim 9, wherein treating the glass structure to substantially remove all solvents and organic components comprises heating the glass structure for a time period of between 24 hours to 96 hours, before the glass structure is exposed to the bath of metal salt.

13. The method of claim 2, wherein the sintering of the glass structure is performed at a temperature of about 1100° C. to about 1500° C.

14. A method for forming a glass structure having a metallized surface portion, the method comprising:
carrying out an additive manufacturing operation to form the glass structure using a flowable first material and a second flowable material, wherein the first flowable material includes SiO₂ and the second flowable material differs from the first material and includes a catalyst, and wherein the second flowable material is applied to form at least a designated portion of an outer surface of the glass structure;
treating the structure to remove substantially all solvents and organic components contained in the first flowable material; and
exposing the glass structure to a bath of a metal salt solution during which nucleation occurs and a metallized surface coating is formed only on the designated portion of the outer surface of the glass structure which includes the second flowable material containing the catalyst, to provide a metallized pattern on the outer surface.

15. (canceled)

16. The method of claim 14, wherein the second flowable material including the catalyst comprises a mixture of at least one of:
SiO₂ and Pd; or
SiO₂, TiO₂ and Pd.

17. The method of claim 14, wherein the bath of the metal salt solution comprises a salt solution including:
a quantity of at least one of copper sulfate or nickel chloride; and
a reducing agent including at least one of formaldehyde and glyoxylic acid.

18. The method of claim 14, further comprising sintering the glass structure prior to exposing the glass structure to the bath of the metal salt solution.

19. A method for forming a glass structure having a metallized surface portion, the method comprising:
carrying out an additive manufacturing operation to form the glass structure using a first flowable material and a second flowable material, wherein the first flowable material includes SiO₂ and the second flowable material differs from the first flowable material and includes a catalyst, and wherein the second flowable material forms an activated portion, as well as a structural portion, of the glass structure and is applied to form at least a designated portion of an outer surface of the glass structure, and the first flowable material forms a remainder of the glass structure;
heating the glass structure during a drying/burnout operation to remove substantially all solvents and organic components contained in the first flowable material;
sintering the glass structure to produce a consolidated structure;
exposing the consolidated structure to a bath of a metal salt solution during which nucleation occurs and a metallized surface coating is formed only on the designated portion of the outer surface of the glass structure containing the second flowable material having the catalyst.
